(19) United States
(12) Patent Application Publication
(10) Pub. No.: US 2004/0068656 A1
(43) Pub. Date: Apr. 8, 2004

(54) Smart card wake up system

(76) Inventor: Max Lu, Hsinchu (TW)

Correspondence Address: Finnegan, Henderson, Farabow,, Garrett & Dunner, L.L.P., 1300 I Street, N.W., Washington, DC, 20005-3315, US

(21) Appl. No.: 10/265,343

(22) Filed: Oct. 7, 2002

(51) Int. Cl. H04L 9/00

(52) U.S. Cl. 713/172; 713/185

(57) ABSTRACT

Systems, methods, and apparatus utilize a smart card as a key to gain access rights to turn on or wake up a device. To turn on or wake up the device, a user may present a smart card to a reader coupled to the device. The smart card reader provides a signal to the device. Upon receiving the signal, the device may then interface with the smart card to authenticate the user. The device may require the user to provide additional information, such as a password or personal identification number. In addition, the device may access another device, e.g., across a network, to authenticate the user. If the user is authenticated, the device may continue with the turn-on or wake-up sequence. If the user is not authenticated, the device may terminate the turn-on or wake-up sequence. In addition, the device may issue an alarm to report a failed access attempt.

### DESCRIPTION OF THE INVENTION

1. Field of the Invention

The principles of the present invention relate to methods, apparatus, and systems to control power to a device, such as a personal computer. In particular, the principles of the present invention relate to controlling power to a device using a card.

2. Background of the Invention

Typically, a computer is turned on using a manually operated on/off switch. For example, in order to start up a computer, a user may operate the on/off switch. Upon operating the on/off switch, power is then supplied to the computer, e.g., via a wall outlet or battery. In addition, a computer may “wake up” from a standby state when a user operates a peripheral of the computer. For example, a computer may enter a standby state after several minutes when the user is not using the computer, but has left the computer turned on. To wake up the computer, the user may then operate a peripheral device of the computer, such as a keyboard or mouse. Unfortunately, typical computers allow any person to turn on or wake up the computer.

Today, computers are used to access a wide variety of systems and information. For example, the Internet allows a person to use a computer to access a system and database from virtually any location. These systems and databases may contain valuable and/or sensitive information. Therefore, since typical computers allow any person to turn on or wake up the computer, an unauthorized person may gain access to valuable and/or sensitive systems and information.

### SUMMARY OF THE INVENTION

In accordance with an aspect of the present invention, a method for controlling power to a device comprises: detecting a presence of a smart card; requesting information indicating an identity of a user based on the presence of the smart card; and selectively providing power to the device based on the information.

In accordance with another aspect of the present invention, an apparatus for controlling power to a device comprises: means for detecting a presence of a smart card; means for requesting information indicating an identity of a user based on the presence of the smart card; and means for selectively providing power to the device based on the information.

In accordance with another aspect of the present invention, a device having a controlled power supply comprises: a detection circuit to receive a presence signal indicating a presence of a smart card; a control circuit to provide a control signal based on the presence signal; and a power supply to selectively provide power to the device based on the control signal.

In accordance with another aspect of the present invention, a method of selectively providing power to a device comprises: detecting a presence of a smart card; conditionally providing power to a processor based on the presence of the smart card; providing instructions to the processor to access the smart card; requesting information from the smart card; verifying the information from the smart card; and providing normal power to the processor when the information from the smart card is verified.

In accordance with yet another aspect of the present invention, an apparatus for selectively providing power to a device comprises: means for detecting a presence of a smart card; means for conditionally providing power to a processor based on the presence of the smart card; means for providing instructions to the processor from a BIOS to access the smart card; means for requesting information from the smart card; means for verifying the information from the smart card; and means for providing normal power to the processor when the information from the smart card is verified.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 shows a system to control power to a device, such as, a computer, consistent with principles of the present invention.

FIG. 2 shows a more detailed view of the device illustrated in FIG. 1.

FIG. 3 shows a process to control power to a device consistent with principles of the present invention.

### DESCRIPTION OF THE EMBODIMENTS

Systems, methods, and apparatus consistent with principles of the present invention utilize a smart card as a key to gain access rights to turn on or wake up a device. To turn on or wake up the device, a user may present a smart card to a reader coupled to the device. In response, the smart card reader provides a signal to the device. Upon receiving the signal, the device may then interface with the smart card to authenticate the user. In the process of authenticating the user, the device may require the user to provide additional information, such as a password or personal identification number. In addition, the device may access another device, e.g., across a network, to authenticate the user. If the user is authenticated, the device may continue with the turn on or wake up sequence. If the user is not authenticated, the device may terminate the turn on or wake up sequence. In addition, the device may issue an alarm to report a failed access attempt.

Reference will now be made in detail to exemplary embodiments consistent with principles of the present invention, examples of which are illustrated in the accompanying drawings. Wherever possible, the same reference numbers will be used throughout the drawings to refer to the same or like parts.

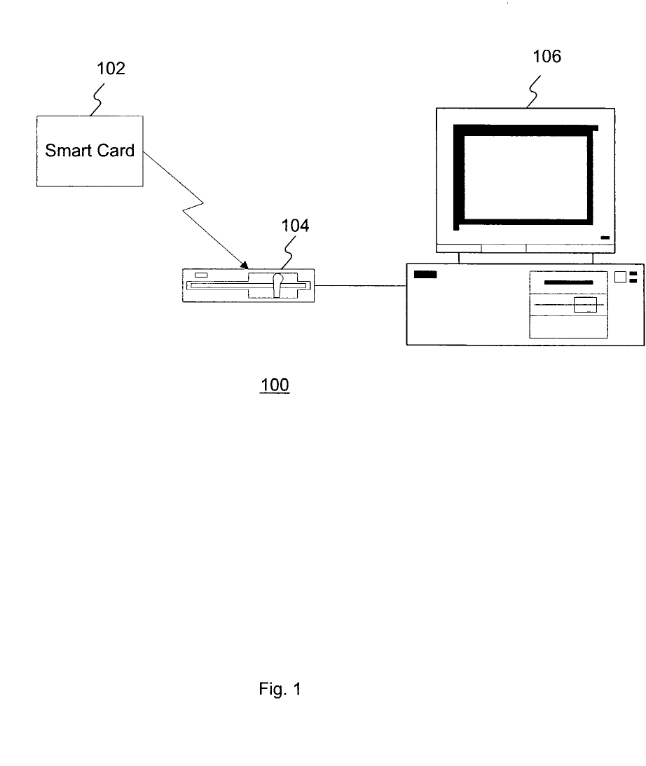

FIG. 1 shows a system 100 to control power to a device, such as, a computer, consistent with principles of the present invention. As shown, system 100 may include a smart card 102, a reader 104, and a device 106.

Smart card 102 contains information to identify the user. Smart card 102 may be issued to the user, e.g., by an employer, an organization, or business. Smart card 102 may include a memory (not shown) to provide information identifying the user. For example, smart card 102 may contain information, such as: cryptographic keys; passwords; personal identification numbers; and biometrics information. However, any type of information may be stored on smart card 102. For example, information such as photographs and text may also be stored on smart card 102.

Smart card 102 may be implemented as a smart card of the type generally known by those skilled in the art. For example, smart card 102 may be a credit card or a credit card sized plastic card having an embedded integrated circuit (not shown). The integrated circuit may include a processor, and a memory, such as a read only memory (ROM), a random access memory (RAM), or an electrically erasable programmable read only memory (EEPROM).

Reader 104 detects the presence of smart card 102 and provides an interface with smart card 102. Reader 104 may detect smart card 102 based upon physical contact. For example, reader 104 may detect smart card 102 as a result of a user inserting smart card 102 into reader 104. Alternatively, reader 104 may detect smart card 102 based upon proximity. For example, a user may place smart card 102 near reader 104, e.g., within an electromagnetic field radiated by reader 104.

Upon detecting the presence of smart card 102, reader 104 provides a signal to device 106. Reader 104 may then provide an interface between device 106 and smart card 102. For example, reader 104 may manage input/output channels between smart card 102 and device 106. In addition, reader 104 may translate information flowing between smart card 102 and device 106. Reader 104 may be implemented using known hardware and software. For example, reader 104 may be implemented using hardware and software that is compatible with Microsoft Windows™.

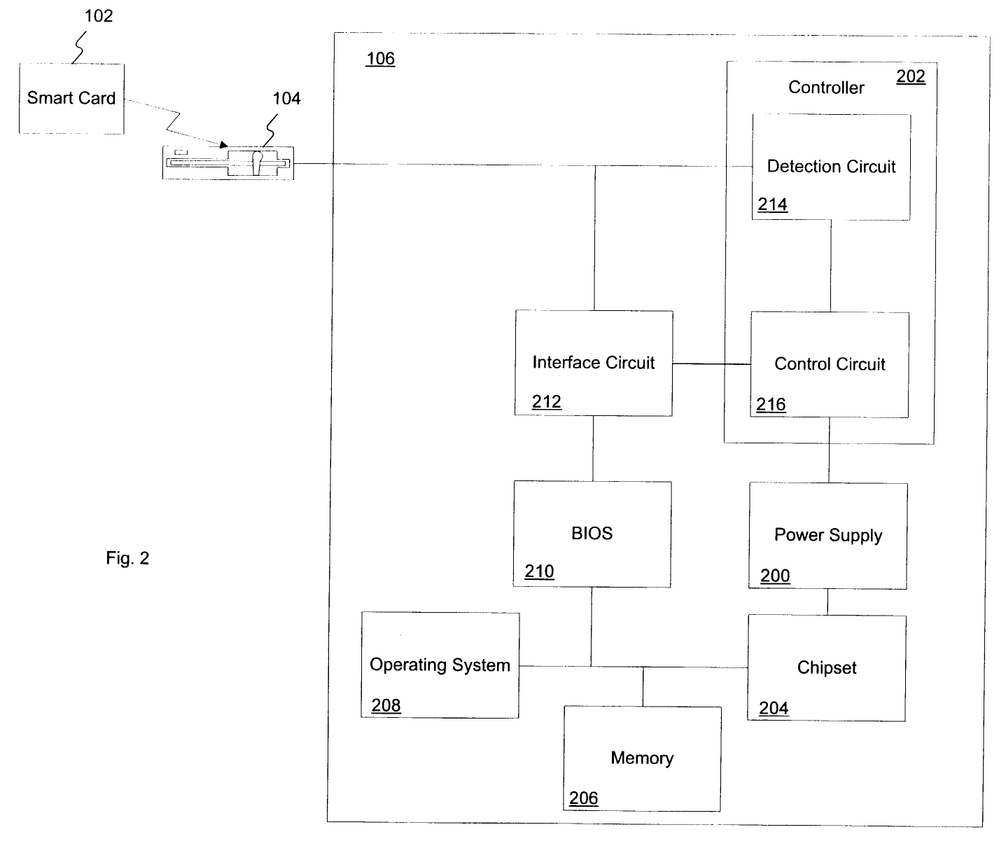

Device 106 may be any device operated by the user, such as a computer. Although FIG. 1 shows a personal computer, device 106 may be a wide variety of devices including: a laptop computer; a personal data assistant (e.g., a Palm™ device), a personal communications device, a mobile telephone, etc. In addition, device 106 may be coupled to a network (not shown) and access other devices. For example, device 106 may be coupled to the Internet and access servers, such as other computers, web servers, authentication servers, etc. Device 106 is described in more detail in reference to FIG. 2.

FIG. 2 shows a more detailed view of device 106 consistent with principles of the present invention. As shown, device 106 may include: a power supply 200; a controller 202; a chipset 204; a memory 206; an operating system 208; a basic input/output system (BIOS) 210; and an interface circuit 212. Device 106 may also include other components consistent with principles of the present invention.

Power supply 200 provides power for device 106 at various voltage levels. For example, power supply 200 may provide power at 12 volts, 5 volts, 3.3 volts, and 0 volts. In addition, power supply 200 may provide “soft-power”, e.g., power that is provided even device 106 is “turned off.” For example, soft-power from power supply 200 allows one or more components (e.g., controller 202) to control when device 106 will turn on or wake up.

Power supply 200 may be implemented using any combination of components according to specifications known to those skilled in the art. For example, the ATX Specification, version 2.01 by the Intel Corporation (February 1997) titled “ATX Specification” describes specifications for implementing power supplies and is incorporated herein by reference in its entirety. The ATX Specification also describes soft-power and refers to soft-power as +5 V standby power, +5VSB, or 5VSB. Other implementations of power supply 200, including different voltage levels, are consistent with principles of the present invention.

Controller 202 provides signals to power supply 200 for controlling power to device 106. In one embodiment, controller 202 relies upon soft-power from power supply 200 and, thus, may control the turn-on or wake-up sequence even when the rest of device 106 is turned off. As shown, controller 202 may include a detection circuit 214 and a control circuit 216. However, controller 202 may be implemented using any number of components.

Detection circuit 214 provides a control signal based upon receiving a signal from reader 104 indicating the presence of smart card 102. For example, reader 104 may provide an active high signal pulse (i.e., a pulse which transitions from logic “0” to logic “1” and back to logic “0”) to detection circuit 214 when smart card 102 is detected. In response, detection circuit 214 may then provide a control signal to control circuit 216. For example, detection circuit 214 may provide an active low signal pulse (i.e., a pulse which transitions from logic “1” to logic “0” and back to logic “1”).

Detection circuit 214 may be implemented using a variety of components known by those skilled in the art. For example, detection circuit 214 may be implemented using a data register and a non-volatile memory. Alternatively, detection circuit 214 may be implemented using software components in combination with hardware components. Further, detection circuit 214 may be implemented using any combination of hardware and software components consistent with principles of the present invention.

Control circuit 216 receives the control signal from detection circuit 214 and provides a power control signal to power supply 200. For example, upon receiving an active low signal pulse from detection circuit 214, control circuit 216 may provide an active low signal pulse to power supply 200. Control circuit 216 may be implemented using any combination of components known by those skilled in the art. For example, control circuit 216 may be implemented using a data register, a comparator, and a non-volatile memory. Alternatively, control circuit 216 may be implemented using a combination of hardware and software components. However, control circuit 216 may be implemented using any combination of components consistent with principles of the present invention.

Chipset 204 provides processing functions for device 106. For example, chipset 204 may include one or more processors, such as those manufactured by the Intel Corporation. However, chipset 204 may include any type of processor consistent with principles of the present invention. More particularly, for example, chipset 204 may include processors, such as application specific integrated circuits and/or reduced instruction set computers.

Memory 206 provides storage space for information and data used by device 106 and may be implemented using a variety of memory types and components. For example, memory 206 may be implemented as a random access memory, a read only memory, a hard disk drive, a floppy disk drive, a compact disk drive, etc.

Operating system 208 provides instructions to chipset 204 for managing various operations of device 106. For example, operating system 208 may provide instructions for: allocating memory 206; task scheduling; data flow between components of device 106; providing an interface between device 106 and external devices, e.g., peripheral devices; and providing a user interface for device 106. Operating system 208 may provide instructions for a wide variety of other functions and applications consistent with principles of the present invention.,

Operating system 208 may be implemented using software known by those skilled in the art. For example, operating system 208 may be implemented using the Microsoft Windows™ software. However, operating system 208 may also be implemented using other software, such as Disk Operating Software, LINUX, UNIX, Palm OS™ and MacOS™, consistent with principles of the present invention.

BIOS 210 provides instructions to chipset 204 for managing basic operations of device 106 and determines what operations chipset 204 can perform without accessing memory 206, e.g., during the turn-on (or boot-up) or wake up sequence. For example, BIOS 210 may include instructions for: controlling input devices coupled to device 106, e.g., a keyboard or mouse; controlling a display device; controlling a disk drive; controlling serial communications; etc. BIOS 210 may include instructions for other basic operations of device 106 consistent with principles of the present invention.

BIOS 210 may be implemented using read-only memory (ROM), e.g., on a flash memory chip. In addition, BIOS 210 may be implemented using a combination of one or more software modules stored on a ROM. However, BIOS 210 may be implemented using any combination of hardware and software consistent with principles of the present invention.

Interface circuit 212 provides an interface between device 106 and smart card 102, e.g., via reader 104. For example, interface circuit 212 may manage one or more input/output channels between device 106 and smart card 102 and translate communications. In addition, interface 212 may be implemented to recognize one or more applications on smart card 102. Interface circuit 212 may be implemented using a combination of hardware and software. For example, interface circuit 212 may be implemented using components, such as a data register, a buffer, one or more processors, a memory, and software instructions stored in the memory. However, interface circuit 212 may be implemented using a wide variety of hardware and software consistent with principles of the present invention.

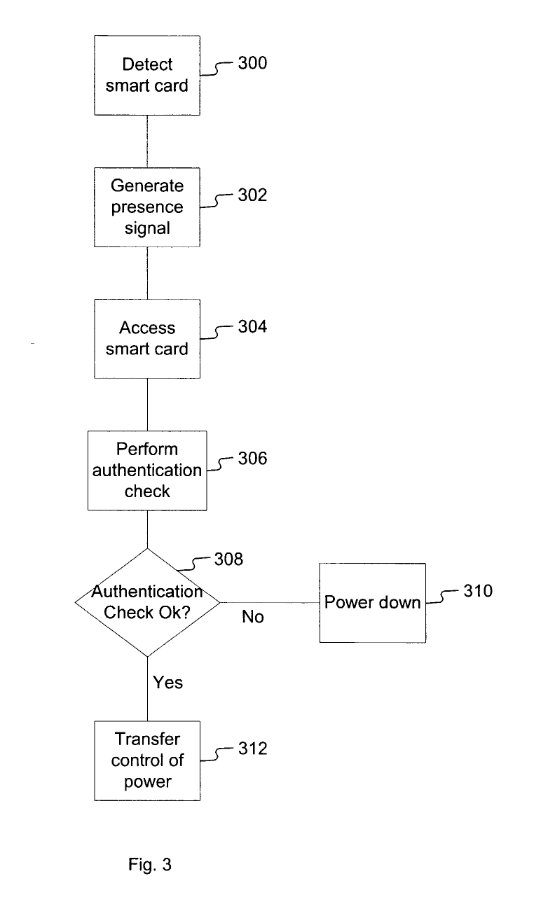

FIG. 3 shows a process to control power to device 106 consistent with principles of the present invention. Device 106 may initially be turned off or in a standby mode (e.g., after a period of inactivity). In order to turn on or wake up device 106, a user may be required to present smart card 102. In addition, the user may be required to present smart card 102 to access selected applications provided by device 106, such as an application containing sensitive information.

In step 300, reader 104 detects the presence of smart card 102. For example, a user may insert smart card 102 into reader 104 or the user may place smart card 102 in proximity to reader 104.

In step 302, reader 104 generates a signal indicating the presence of smart card 102. Reader 104 may then provide the presence signal to device 106. For example, reader 104 may provide an active high signal pulse to detection circuit 214. Detection circuit 214 may then provide a control signal to control circuit 216. Control circuit 216 may then provide a power control signal to power supply 200. In response, power supply 200 may selectively provide power to chipset 204 which is conditional based upon authentication of information on smart card 102, e.g., conditional power.

In step 304, chipset 204 accesses smart card 102. For example, upon receiving power from power supply 200, chipset 204 may access BIOS 210 to retrieve instructions for accessing smart card 102. Alternatively, chipset 204 may access operating system 208 and memory 206 to retrieve instructions for accessing smart card 102. Chipset 204 may then provide instructions to interface circuit 212. In response, interface 212 may initiate one or more input/output channels with smart card 102 via reader 104 and issue one or more commands to smart card 102.

In step 306, authentication information is requested. For example, the user may be prompted to provide identification information, such as a password, personal identification number, biometric information, etc. Alternatively, the identification information may be provided directly from smart card 102 without prompting the user. However, any type of information may be requested consistent with principles of the present invention.

In step 308, the authentication information is verified. The authentication information may be verified by smart card 102. For example, smart card 102 may access it's integrated circuit to verify the identification information provided by the user. Alternatively, the authentication information may be verified by device 106 in conjunction with smart card 102. For example, chipset 204 may access smart card 102 and BIOS 210 to verify the identification information. As another alternative, chipset 204 may access operating system 208 and memory 206 to verify the identification information. In addition, device 106 may remotely access another device, such as a server connected via a network (not shown) coupled to device 106, to verify the identification information. Other ways of verifying the authentication information are consistent with principles of the present invention. If the authentication information is not verified, then processing flows to step 310.

In step 310, the authentication information is not verified, e.g., indicating an unauthorized user, and device 106 powers down. For example, in order to initiate a power down, smart card 102 may provide instructions to interface circuit 212 and, in response, interface circuit 212 may then provide a signal to control circuit 216. Control circuit 216 may then provide a power control signal to power supply 200 to turn off the conditional power to chipset 204. Alternatively, chipset 204, e.g., in conjunction with BIOS 210 or operating system 208, may provide instructions to interface circuit 212 to turn off the conditional power signal from power supply 200.

Furthermore, the user may be allowed a limited number of attempts to provide authentication information before device 106 powers down. For example, the user may be allowed 3 attempts within a certain period of time to provide authentication information. In addition, device 106 may provide an alarm or report, e.g., to another device connected via a network (not shown), when an attempted authentication has failed.

If the authentication information is verified, then processing flows to step 312. In step 312, chipset 204 may provide one or more signals to continue with normal operations. For example, chipset 204 may access BIOS 210 to begin normal turn on or wake up sequences and provide a signal to power supply 200 to transition to normal power signal operations. Chipset 204 may then access operating system 208 and memory 206 to allow the user to access various applications provided by device 106.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for controlling power to a device, comprising:
detecting a presence of a smart card;
requesting information indicating an identity of a user based on the presence of the smart card; and
selectively providing power to the device based on the information.

2. The method of claim 1, wherein detecting the presence of the smart card comprises detecting an insertion of the smart card into a reader coupled to the device.

3. The method of claim 1, wherein detecting the presence of the smart card comprises detecting a proximity of the smart card to a reader coupled to the device.

4. The method of claim 1, wherein requesting information indicating an identity of the user comprises accessing identification information stored on the smart card.

5. The method of claim 1, wherein requesting information indicating an identity of the user comprises accessing information stored in a memory within the device.

6. The method of claim 1, wherein requesting information indicating an identity of the user comprises accessing at least one additional device.

7. The method of claim 1, wherein requesting information indicating an identity of the user comprises prompting the user to provide identification information.

8. An apparatus for controlling power to a device, comprising:
means for detecting a presence of a smart card;
means for requesting information indicating an identity of a user based on the presence of the smart card; and
means for selectively providing power to the device based on the information.

9. A device having a controlled power supply, comprising:
a detection circuit to receive a presence signal indicating a presence of a smart card;
a control circuit to provide a control signal based on the presence signal; and
a power supply to selectively provide power to the device based on the control signal.

10. The device of claim 9, further comprising:
a reader, coupled to the detection circuit, to detect the presence of the smart card and provide the presence signal.

11. The device of claim 10, further comprising:
an interface system coupled to the control circuit and the reader to access the smart card.

12. The device of claim 11, further comprising:
a BIOS coupled to the interface system to provide one or more instructions to the interface system.

13. The device of claim 9, wherein the power supply is an ATX compatible power supply.

14. The device of claim 9, wherein the detection circuit and control circuit are powered using a soft-power from the power supply.

15. A method of selectively providing power to a device, comprising:
detecting a presence of a smart card;
conditionally providing power to a processor based on the presence of the smart card;
providing instructions to the processor to access the smart card;
requesting information from the smart card;
verifying the information from the smart card; and
providing normal power to the processor when the information from the smart card is verified.

16. The method of claim 15, further comprising:
terminating the conditional power signal when the information from the smart card is not verified.

17. The method of claim 15, wherein providing instructions to the processor to access the smart card comprises accessing a BIOS.

18. The method of claim 15, wherein providing instructions to the processor to access the smart card comprises accessing an operating system.

19. The method of claim 15, wherein providing instructions to the processor to access the smart card comprises accessing at least one additional device via a network.

20. An apparatus for selectively providing power to a device, comprising:
means for detecting a presence of a smart card;
means for conditionally providing power to a processor based on the presence of the smart card;
means for providing instructions to the processor from a BIOS to access the smart card;
means for requesting information from the smart card;
means for verifying the information from the smart card; and
means for providing normal power to the processor when the information from the smart card is verified.
